(19) United States
(12) Patent Application Publication
(10) Pub. No.: US 2025/0106919 A1
(43) Pub. Date: Mar. 27, 2025

(54) APPARATUS AND METHOD FOR PAYMENT USING UWB COMMUNICATION

(71) Applicant: SAMSUNG ELECTRONICS CO., LTD., Suwon-si (KR)

(72) Inventors: Sungdong KIM, Suwon-si (KR); Kisoo AN, Suwon-si (KR); Gyubong OH, Suwon-si (KR)

(21) Appl. No.: 18/900,234

(22) Filed: Sep. 27, 2024

(30) Foreign Application Priority Data
Sep. 27, 2023 (KR) 10-2023-0130440

(51) Int. Cl. H04W 76/14; G01S 13/74; G06Q 20/32; H04W 76/15

(52) U.S. Cl. CPC H04W 76/14; G06Q 20/327; H04W 76/15; G01S 13/74

(57) ABSTRACT

An operation method of a first electronic apparatus in a wireless communication system according to an embodiment of the disclosure may include an operations of receiving, from a second electronic apparatus, a Bluetooth low energy (BLE) advertisement message including an indicator indicating a state in which the first electronic apparatus moves into a configured place or a state in which the electronic apparatus moves out of the configured place, identifying whether the first electronic apparatus is to move into the configured place or move out of the configured place, establishing, in case that a result of the identification corresponds to the indicator, a BLE connection with the second electronic apparatus and receiving ultra-wideband (UWB) connection information from the second electronic apparatus, and establishing a UWB connection with the second electronic apparatus and performing UWB ranging with the second electronic apparatus based on the UWB connection information.

### CROSS-REFERENCE TO RELATED APPLICATION

This application is based on and claims priority under 35 U.S.C. § 119 to Korean Patent Application No. 10-2023-0130440, filed on Sep. 27, 2023, in the Korean Intellectual Property Office, the disclosure of which is herein incorporated by reference in its entirety.

### BACKGROUND

### 1. Field

The disclosure relates to a method for controlling an electronic apparatus using ultra-wideband (UWB) communication and, more specifically, to a remote payment method using UWB communication.

### 2. Description of Related Art

The Internet, which is a human centered connectivity network where humans generate and consume information, is now evolving to the Internet of things (IoT) where distributed entities, such as things, exchange and process information. The Internet of everything (IoE), which is a combination of the IoT technology and the big data processing technology through a connection with a cloud server, etc. has emerged. As technology elements, such as “sensing technology”, “wired/wireless communication and network infrastructure”, “service interface technology”, and “security technology” have been demanded for IoT implementation. Recently, a sensor network, a machine-to-machine (M2M) communication, machine type communication (MTC), and so forth have been researched.

Such an IoT environment may provide intelligent Internet technology (IT) services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

With the advance of wireless communication systems as described above, various services can be provided, and accordingly there is a need for ways to effectively provide these services. For example, ranging technology for measuring the distance between electronic devices by using an ultra wide band may be used. A need for technology to assist in remote payment by using the ranging technology between electronic devices has emerged.

### SUMMARY

The disclosure suggests a method for performing remote payment performed by an electronic apparatus using a ranging technology through UWB communication.

An operation method of a first electronic apparatus in a wireless communication system according to an embodiment of the disclosure may include an operation of receiving, from a second electronic apparatus, a Bluetooth low energy (BLE) advertisement message including an indicator indicating a state in which the first electronic apparatus moves into a configured place or moves out of the configured place, an operation of identifying whether the first electronic apparatus is to move into the configured place or move out of the configured place, an operation of establishing, in case that a result of the identification corresponds to the indicator, a BLE connection with the second electronic apparatus and receiving ultra-wideband (UWB) connection information from the second electronic apparatus, and an operation of establishing a UWB connection with the second electronic apparatus and performing UWB ranging with the second electronic apparatus, based on the UWB connection information.

An operation method of a second electronic apparatus in a wireless communication system according to an embodiment of the disclosure may include an operation of transmitting, to a first electronic apparatus, a Bluetooth low energy (BLE) advertisement message including an indicator indicating a state in which the first electronic apparatus moves into a configured place or a state in which the first electronic apparatus moves out of the configured place, an operation of establishing a BLE connection with the first electronic apparatus and transmitting ultra-wideband (UWB) connection information to the first electronic apparatus, and an operation of establishing a UWB connection with the first electronic apparatus and performing UWB ranging based on the UWB connection information.

A first electronic apparatus in a wireless communication system according to an embodiment of the disclosure may include a transmission/reception unit and a controller. The controller may receive, from a second electronic apparatus, a Bluetooth low energy (BLE) advertisement message including an indicator indicating a state in which the first electronic apparatus moves into a configured place or a state in which the first electronic apparatus moves out of the configured place, identify whether the first electronic apparatus is to move into the configured place or move out of the configured place, establish, in case that a result of the identification corresponds to the indicator, a BLE connection with the second electronic apparatus and receive ultra-wideband (UWB) connection information from the second electronic apparatus, and establish a UWB connection with the second electronic apparatus and perform UWB ranging with the second electronic apparatus, based on the UWB connection information.

A second electronic apparatus in a wireless communication system according to an embodiment may include a transmission/reception unit and a controller. The controller may transmit, to a first electronic apparatus, a Bluetooth low energy (BLE) advertisement message including an indicator indicating a state in which the first electronic apparatus moves into a configured place of a state in which the first electronic apparatus moves out of the configured place, establish a BLE connection with the first electronic apparatus and transmit ultra-wideband (UWB) connection information to the first electronic apparatus, and establish a UWB connection with the first electronic apparatus and perform UWB ranging based on the UWB connection information.

An electronic apparatus according to an embodiment of the disclosure may efficiently control remote payment by the electronic apparatus by using a ranging technology through UWB communication.

The electronic apparatus according to an embodiment of the disclosure may minimize a user operation when performing remote payment by using a ranging technology through UWB communication and provide convenience when moving a vehicle into or out of a parking lot.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of the disclosure will be more apparent from the following detailed description taken in conjunction with the accompanying drawings, in which:

FIG. 1 illustrates an architecture of an electronic apparatus according to an embodiment of the disclosure.

FIG. 2 illustrates a communication system including multiple electronic apparatuses according to an embodiment of the disclosure.

FIG. 3 illustrates a method for multiple electronic apparatuses to perform communication according to an embodiment of the disclosure.

FIG. 4 illustrates a view of a payment method of a vehicle using BLE communication and UWB communication according to an embodiment of the disclosure.

FIG. 5A illustrates an example of a case in which there are parking barriers having different directions in a parking lot according to an embodiment of the disclosure.

FIG. 5B illustrates an example of a case in which there are parking barriers having an identical direction in a parking lot according to an embodiment of the disclosure.

FIG. 6A illustrates an example of a case in which it is impossible to recognize a vehicle moving into a payment range in a case of payment within a parking lot using UWB communication according to an embodiment of the disclosure.

FIG. 6B illustrates an example of a case in which it is impossible to recognize a location of a vehicle in a case of payment within a parking lot using UWB communication according to an embodiment of the disclosure.

FIG. 7 illustrates an example of a method for detecting movement of a vehicle within a parking lot using UWB communication according to an embodiment of the disclosure.

FIG. 8A illustrates an example of BLE advertisement data according to an embodiment of the disclosure.

FIG. 8B illustrates another example of BLE advertisement data according to an embodiment of the disclosure.

FIG. 9 illustrates a process in which BLE advertisement data is transmitted or received according to an embodiment of the disclosure.

FIG. 10 illustrates a registration process between parking barriers according to an embodiment of the disclosure.

FIG. 11A illustrates an example of BLE advertisement data according to an embodiment of the disclosure.

FIG. 11B illustrates another example of BLE advertisement data according to an embodiment of the disclosure.

FIG. 12 illustrates a UWB connection and ranging process between a terminal and a parking barrier according to an embodiment of the disclosure.

FIG. 13A illustrates an example of a process for acquiring location information of an electronic apparatus through UWB communication between two parking barriers and the electronic apparatus according to an embodiment of the disclosure.

FIG. 13B illustrates an example of a process for acquiring location information of an electronic apparatus through UWB communication between two parking barriers and the electronic apparatus according to an embodiment of the disclosure.

FIGS. 14A and 14B illustrate a process of an electronic apparatus moving into a parking lot in a situation in which multiple parking barriers exist according to an embodiment of the disclosure.

FIGS. 15A and 15B illustrate a process of an electronic apparatus moving out of a parking lot in a situation in which multiple parking barriers exist according to an embodiment of the disclosure.

FIG. 16 illustrates a block diagram of a structure of a first electronic apparatus according to an embodiment of the disclosure.

FIG. 17 illustrates a block diagram of a structure of a second electronic apparatus according to an embodiment of the disclosure.

### DETAILED DESCRIPTION

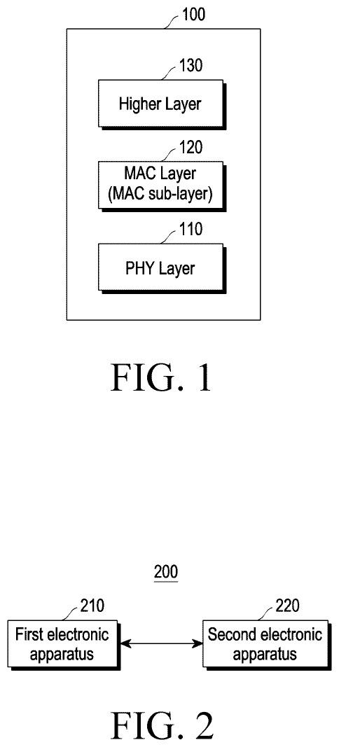

FIGS. 1 through 17, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a field programmable gate array (FPGA) or an application specific integrated circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in various embodiments of the disclosure may include one or more processors.

As used herein, the term “terminal” or “device” may also be referred to as a mobile station (MS), a user equipment (UE), a user terminal (UT), a wireless terminal, an access terminal (AT), a terminal, a subscriber unit, a subscriber station (SS), a wireless device, a wireless communication device, a wireless transmit/receive unit (WTRU), a mobile node, a mobile, or other terms. Various examples of the terminal may include a cellular phone, a smartphone having a wireless communication function, a personal digital assistant (PDA) having a wireless communication function, a wireless modem, a portable computer having a wireless communication function, a photographing device such as a digital camera having a wireless communication function, a gaming device having a wireless communication function, a music storage and playback home appliance having a wireless communication function, an Internet home appliance capable of wireless Internet access and browsing, and portable units or terminals having integrated combinations of these functions. Furthermore, the terminal may include a machine to machine (M2M) terminal, and a machine type communication (MTC) terminal/device, but is not limited thereto. In the specification, the terminal may also be referred to as an electronic device or simply as a device.

Hereinafter, the operation principle of the disclosure will be described in detail in conjunction with the accompanying drawings. In describing the disclosure below, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

Hereinafter, embodiments of the disclosure will be described in detail in conjunction with the accompanying drawings. In the following description of embodiments of the disclosure, a communication system using UWB will be described by way of example, but the embodiments of the disclosure may be applied to other communication systems having similar technical backgrounds or characteristics. Examples of such communication systems may include communication systems Bluetooth or ZigBee. Therefore, based on determinations by those skilled in the art, the embodiments of the disclosure may be applied to other communication systems through some modifications without significantly departing from the scope of the disclosure.

In describing the disclosure below, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In general, a wireless sensor network technology may be largely divided into a wireless local area network (WLAN) technology and a wireless personal area network (WPAN) technology depending on a recognition distance. Here, the WLAN corresponds to a technology based on IEEE 802.11 and is a technology allowing access to the backbone network within a radius of about 100 m. In addition, the WPAN is a technology based on IEEE 802.15 and includes Bluetooth, ZigBee, ultra-wideband (UWB), or the like. A wireless network in which such wireless network technology is implemented may include multiple electronic apparatuses.

According to the definition of the Federal Communications Commission (FCC), UWB may refer to a wireless communication technology that uses a bandwidth of 500 MHz or more, or has a bandwidth of 20% or more corresponding to the center frequency. The UWB may refer to a band itself, to which UWB communication is applied. The UWB allows secure and accurate ranging between apparatuses. As such, the UWB allows relative location estimation based on a distance between two apparatuses or accurate location estimation of a apparatus based on a distance from fixed apparatuses (with known locations).

The specific terms as used in the following description are provided to help an understanding of the disclosure, and these specific terms may be used in different forms without departing from the technical idea of the disclosure.

A “controller” may correspond to a ranging device configured to define and control a ranging control message (RCM) (or a control message).

A “controllee” may correspond to a ranging device using a ranging parameter within the RCM (or the control message) received from the controller.

The “ranging device” may refer to a device which may perform UWB ranging. In the disclosure, the ranging device may correspond to an enhanced ranging device (ERDEV) defined in IEEE 802.15.4z or a FiRa device defined in FiRa. The ranging device may be referred to as a UWB device.

An “initiator” may correspond to a ranging device configured to initiate ranging exchange.

A “responder” may correspond to a ranging device configured to respond to an initiator in ranging exchange.

A “UWB message” may correspond to a message including payload IE transmitted by a UWB device (e.g., ERDEV).

A “ranging message” may correspond to a message transmitted by the UWB device (e.g., ERDEV) in the UWB ranging procedure. For example, the ranging message may include messages, such as a ranging initiation message (RIM), a ranging response message (RRM), a ranging final message (RFM), and a measurement report message (MRM), which are transmitted by the UWB device (e.g., ERDEV) in a specific phase of the ranging round. The ranging message may include one or more UWB messages. If necessary, multiple ranging messages may be integrated into one message. For example, in case of non-deferred DS-TWR ranging, the RFM and the MRM may be integrated into one message in a ranging final phase.

A “UWB channel” may correspond to one of candidate UWB channels allocated for UWB communication. The candidate UWB channels allocated for UWB communication may correspond to channels allocated for UWB communication defined in IEEE 802.15.4/4z. The UWB channel may be used for UWB ranging and/or transaction. For example, the UWB channel may be used for transmission or reception of a ranging frame (RFRAME) and/or transmission or reception of a data frame.

A “narrow-band (NB) channel” may correspond to a channel having a bandwidth narrower than that of the UWB channel. The NB channel may correspond to a sub-channel of one of candidate UWB channels allocated for UWB communication. The NB channel may correspond to a channel allocated for another communication technology other than the UWB communication. The NB channel may be used for a connection configuration for advertising, apparatus discovery and/or additional parameter negotiation/authentication. For example, the NB channel may be used for transmission or reception of an advertisement message, an additional advertising message, a connection request message, and/or a connection identification message.

Furthermore, in describing the disclosure, a detailed description of known functions or configurations incorporated herein will be omitted when it is determined that the description may make the subject matter of the disclosure unnecessarily unclear.

Hereinafter, various embodiments of the disclosure will be described with reference to the accompanying drawings.

FIG. 1 illustrates an architecture of an electronic apparatus according to an embodiment of the disclosure.

In the disclosure, the electronic apparatus may be one of various types of electronic apparatuses. For example, the electronic apparatus may include a portable apparatus (e.g., a vehicle, a UE, a smartphone, a wearable apparatus, or a tag apparatus), or a stationary apparatus (e.g., a door lock, an anchor apparatus, or the like).

Referring to FIG. 1, the electronic apparatus 100 may include a PHY layer 110, a MAC layer (MAC sub-layer) 120, and/or a higher layer 130.

### (1) PHY Layer

The PHY layer 110 may include a low-level control entity and at least one transceiver. In the disclosure, the transceiver may be referred to as an RF transceiver or a radio transceiver.

As an embodiment, the at least one transceiver may include a first transceiver configured to support UWB communication (e.g., UWB communication based on 802.15.4z), a second transceiver configured to support NB communication using a bandwidth narrower than that of the UWB communication, and/or a third transceiver configured to support another communication technology (e.g., Wi-Fi, BLE, or the like). In the disclosure, the first transceiver may be referred to as a UWB transceiver, the second transceiver may be referred to as an NB transceiver, and the third transceiver may be referred to as an out-of-band (OOB) transceiver. Meanwhile, according to an embodiment, one transceiver may support multiple communication technologies. For example, one transceiver may support the UWB communication and the NB communication.

As an embodiment, the PHY layer 110 may support at least one of following functions:
transceiver activation and deactivation function (transceiver on/off function)
energy detection function
channel selection function
clear channel assessment (CCA) function
synchronization function
low-level signaling function
UWB ranging, positioning, and localization function
spectrum resource management function
function of packet transmission/reception through physical medium

### (2) MAC Layer

The MAC layer 120 may provide an interface between the higher layer 130 and the PHY layer 120.

As an embodiment, the MAC layer 120 may provide two services as follows:
MAC data service: A service allowing transmission or reception of a MAC protocol data unit (PDU) through the PHY
MAC management service: A service interfacing to an MAC sub-layer management entity (MLME) service access point (SAP) (MLME-SAP)

As an embodiment, the MAC layer 120 may support at least one of functions as follows:
apparatus discovery and connection configuration function
channel access function (access function with respect to a physical channel (e.g., an NB channel/UWB channel/OOB channel))
synchronization function
energy detection-based interference mitigation function
NB signaling-related function
guaranteed timeslot (GTS) management function
frame delivery function
UWB ranging function
PHY parameter change notification function
security function

### (3) Higher Layer

The higher layer 130 may include a network layer configured to provide functions such as network configuration and message routing and/or an application layer configured to provide an intended function of an apparatus. As an embodiment, the application layer may correspond to a UWB-enabled application layer configured to provide a UWB service.

FIG. 2 illustrates a communication system including multiple electronic apparatuses according to an embodiment of the disclosure.

Referring to FIG. 2, the communication system 200 may include a first electronic apparatus 210 and a second electronic apparatus 220. As an embodiment, the first electronic apparatus 210 and/or the second electronic apparatus 220 may be the electronic apparatus 100 in FIG. 1.

The first electronic apparatus 210 may communicate with the second electronic apparatus 220 for apparatus discovery, connection configuration, ranging (e.g., UWB ranging), data communication, and/or other purposes.

The first electronic apparatus 210 may communicate with the second electronic apparatus 220 by using a preconfigured communication scheme (technology). For example, the first electronic apparatus 210 may perform wireless communication with the second electronic apparatus 220 by using a UWB communication scheme, an NB communication scheme, and/or an OOB communication scheme.

In the disclosure, the UWB communication scheme may allow communication to be performed by using at least one of candidate UWB channels allocated for UWB communication.

The NB communication may support at least one NB channel having a bandwidth narrower than that of a UWB channel. As an embodiment, the NB channel may correspond to a sub-channel of at least one of candidate UWB channels allocated for UWB communication. As an embodiment, the NB channel may correspond to a sub-channel of at least one of channels allocated for wireless communication other than the UWB communication.

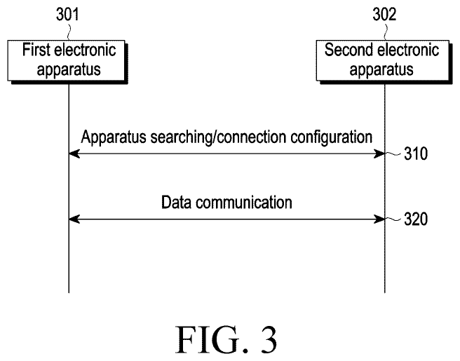

FIG. 3 illustrates a method for multiple electronic apparatuses to perform communication according to an embodiment of the disclosure.

A first electronic apparatus 301 and/or a second electronic apparatus 302 in FIG. 3 may be, for example, the electronic apparatus in FIG. 1 or 2.

Referring to FIG. 3, the first electronic apparatus 301 and the second electronic apparatus 302 may perform an apparatus search/connection configuration procedure 310 and a data communication procedure 320. The apparatus search/connection configuration procedure 310 and the data communication procedure 320 may be managed or controlled by the MAC layer (entity) of the electronic apparatuses.

### (1) Apparatus Search/Connection Configuration Procedure

In the disclosure, the apparatus search/connection configuration procedure 310 may be a preliminary procedure performed before the data communication procedure 320. As an embodiment, the apparatus search/connection configuration procedure 310 may be performed through OOB communication (channel), NB communication (channel), and/or UWB communication (channel).

The apparatus search/connection configuration procedure 310 may include at least one of the following operations:
apparatus search operation: an operation in which an electronic apparatus searches for (discovering) another UWB apparatus. The apparatus search operation may include an operation of transmitting/receiving an advertisement message. In the disclosure, the apparatus search operation may be referred to as a discovery operation or an advertising operation.
connection configuration operation: an operation in which two electronic apparatuses configures connection. The connection configuration operation may include an operation of transmitting/receiving a connection request message and a connection confirmation message. Connection (channel) configured through the connection configuration operation may be used to configure and control a UWB session for data communication. For example, through a secure channel configured through the connection configuration operation, parameters for configuring a UWB session (e.g., a UWB performance parameter (controllee performance parameter), a UWB configuration parameter, and a session key-related parameter) may be negotiated between two electronic apparatuses.

### (2) Data Communication Procedure

In the disclosure, the data communication procedure 320 may correspond to a procedure in which data is transmitted/received using UWB communication. As an embodiment, the data communication procedure may be performed using UWB communication or NB communication.

The data communication procedure 320 may include at least one of the following operations:
UWB ranging operation: an operation in which an electronic apparatus performs UWB ranging with another electronic apparatus according to a preconfigured UWB ranging scheme (e.g., an OWR, SS-TWR, or DS-TWR scheme). As an embodiment, the UWB ranging operation may include a ToF measurement operation and/or an AoA measurement operation.
transaction operation: an operation in which an electronic apparatus exchanges service data with another electronic apparatus.

The disclosure proposes a method for identifying whether an electronic apparatus (or a vehicle with an electronic apparatus on board) moves into a specific place by exchanging data between electronic apparatuses through ultra-wideband (UWB) communication and/or a Bluetooth low energy (BLE) communication.

Furthermore, the disclosure proposes a method of paying a fee (e.g., parking fee payment) in case that an electronic apparatus (or a vehicle with an electronic apparatus on board) moves out of a specific place, by exchanging data between electronic apparatuses through ultra-wideband (UWB) communication and/or a Bluetooth low energy (BLE) communication.

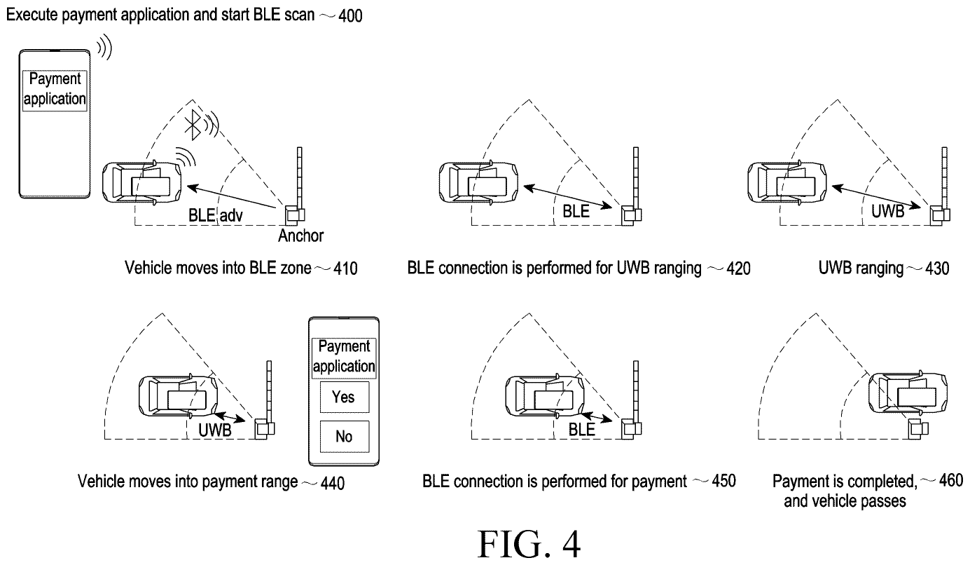

FIG. 4 illustrates a view of a payment method of a vehicle using BLE communication and UWB communication according to an embodiment of the disclosure.

Referring to FIG. 4, in operation 400, an electronic apparatus may execute a payment application in response to a user input and initiate a BLE scan.

In operation 410, in case that the user equipped with the electronic apparatus gets into a vehicle and the vehicle moves into a BLE zone, the electronic apparatus may receive BLE advertisement data transmitted by an anchor (parking barrier). According to an embodiment, the electronic apparatus may scan BLE advertisement data notifying a service for UWB ranging and/or payment in a UWB payment service.

In operation 420, the electronic apparatus in the vehicle may establish BLE connection for the UWB ranging with the anchor (parking barrier). In operation 430, the electronic apparatus in the vehicle and the anchor (parking barrier) may perform the UWB ranging.

In operation 440, in case that the vehicle carrying the user equipped with the electronic apparatus moves into a payment zone, information about whether payment will proceed may be displayed on a display by a payment application in the electronic apparatus. The electronic apparatus may receive a user input with respect to whether the payment will proceed through the application. In operation 450, the electronic apparatus may establish BLE connection with the anchor (parking barrier) for the payment. In operation 460, the electronic apparatus may complete the payment through the BLE communication and/or the UWB communication with the anchor (parking barrier), and the vehicle carrying the user equipped with the electronic apparatus may pass through the anchor (parking barrier).

The electronic apparatus may scan BLE advertisement data notifying a service for the UWB ranging and/or payment in the UWB payment service. Meanwhile, in case that there are multiple parking barriers (or multiple anchors) configured to provide the same service, it is possible that the electronic apparatus is not connected to an appropriate parking barrier for a corresponding situation.

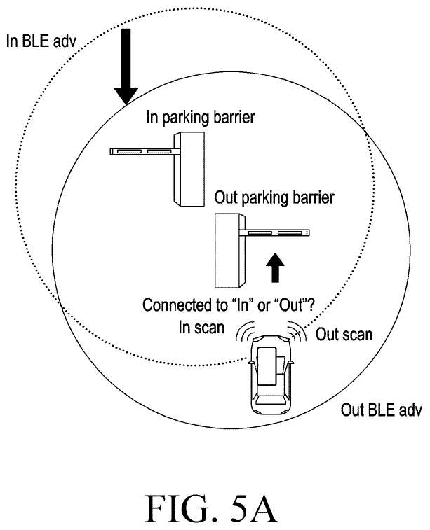

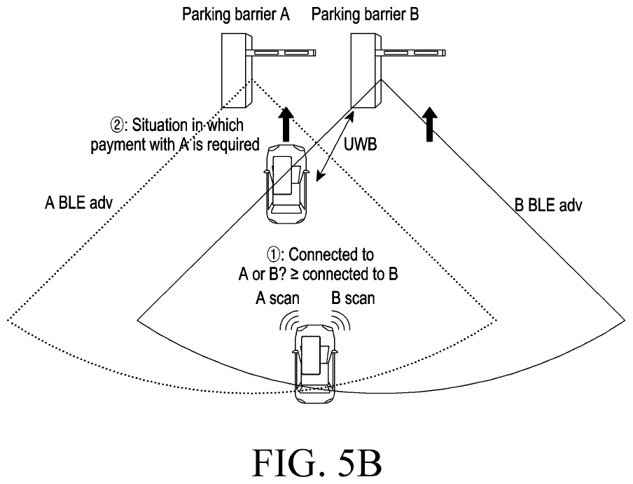

FIG. 5A illustrates an example of a case in which there are parking barriers having different directions in a parking lot according to an embodiment of the disclosure.

Referring to FIG. 5A, each of a first parking barrier (in parking barrier) and a second parking barrier (out parking barrier) existing in the parking lot and having different directions may transmit BLE advertisement data. The electronic apparatus existing in the vehicle may be connected to a parking barrier which is first scanned when the BLE scan is performed for service connection, leading to a problem that the electronic apparatus is connected to an undesired parking barrier.

FIG. 5B illustrates an example of a case in which there are parking barriers having an identical direction in a parking lot according to an embodiment of the disclosure.

Referring to FIG. 5B, each of a first parking barrier (parking barrier A) and a second parking barrier (parking barrier B) existing in the parking lot and having an identical direction may transmit BLE advertisement data. The electronic apparatus existing in the vehicle may be connected to a parking barrier which is first scanned when the BLE scan is performed for service connection, leading to a problem that the electronic apparatus is connected to an undesired parking barrier so that the vehicle enters another path.

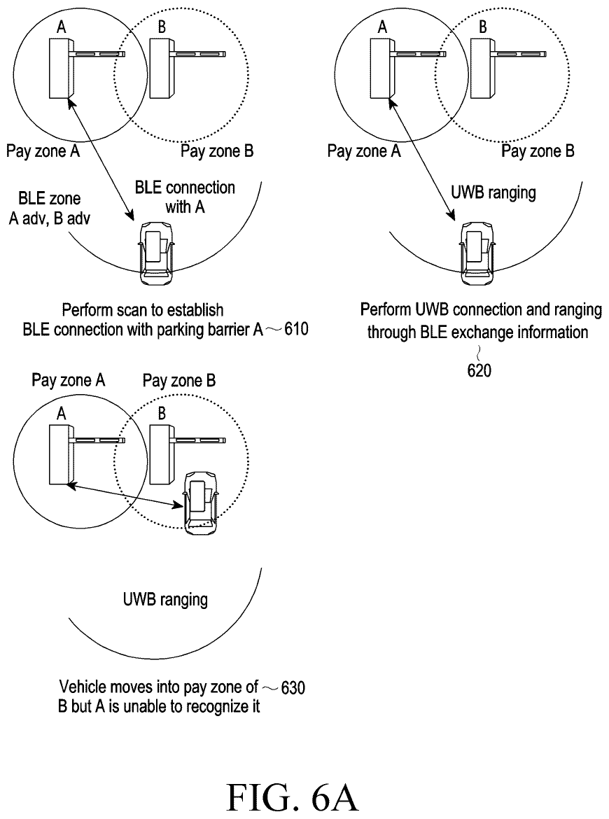

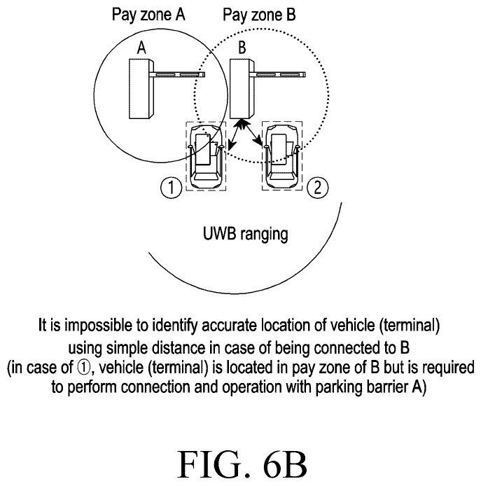

FIG. 6A illustrates an example of a case in which it is impossible to recognize a vehicle moving into a payment range in a case of payment within a parking lot using UWB communication according to an embodiment of the disclosure.

Referring to FIG. 6A, a first parking barrier (parking barrier A) and a second parking barrier (parking barrier B) existing in the parking lot and having an identical direction may each transmit BLE advertisement data, a first payment zone (pay zone A) for the first parking barrier (parking barrier A) may be configured, and a second payment zone (pay zone B) for the second parking barrier (parking barrier B) may be configured.

In operation 610, the electronic apparatus in the vehicle may be located in a BLE area, may scan the BLE advertisement data transmitted by the first parking barrier (parking barrier A), and may be in BLE connection with the first parking barrier (parking barrier A).

In operation 620, the electronic apparatus in the vehicle may exchange information with the first parking barrier (parking barrier A) through the BLE communication and perform the UWB connection and ranging with the first parking barrier (parking barrier A).

In operation 630, in case that the electronic apparatus in the vehicle moves into the second payment zone (pay zone B) for the second parking barrier (parking barrier B), the first parking barrier (parking barrier A) may not recognize the electronic apparatus in the vehicle moving into the second payment zone (pay zone B).

FIG. 6B illustrates an example of a case in which it is impossible to recognize a location of a vehicle in a case of payment within a parking lot using UWB communication according to an embodiment of the disclosure.

Referring to FIG. 6B, in case that the electronic apparatus in the vehicle is connected to the second parking barrier (parking barrier B), it may be difficult to identify an accurate location of the electronic apparatus in the vehicle only using a distance. In case of part 1 in FIG. 6B, although located in the second payment zone (pay zone B) for the second parking barrier (parking barrier B), the electronic apparatus in the vehicle needs to be connected to the first parking barrier (parking barrier A).

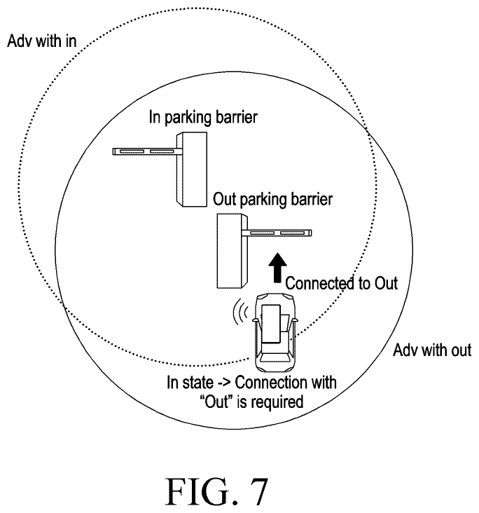

FIG. 7 illustrates an example of a method for detecting movement of a vehicle within a parking lot using UWB communication according to an embodiment of the disclosure.

Referring to FIG. 7, each of a first parking barrier (in parking barrier) and a second parking barrier (out parking barrier) existing in the parking lot and having different directions may transmit BLE advertisement data. The electronic apparatus existing in the vehicle may be connected to a parking barrier which is first scanned when the BLE scan is performed for service connection.

In case that a first area in which the first parking barrier (In parking barrier) transmits BLE advertisement data and a second area in which the second parking barrier (Out parking barrier) transmits BLE advertisement data overlap each other, there may be a situation in which the electronic apparatus in the vehicle receives BLE advertising data from the first parking barrier (In parking barrier) in priority so as to be connected to the first parking barrier (In parking barrier), and then needs to be connected to the second parking barrier (Out parking barrier) so as to move out of the parking lot.

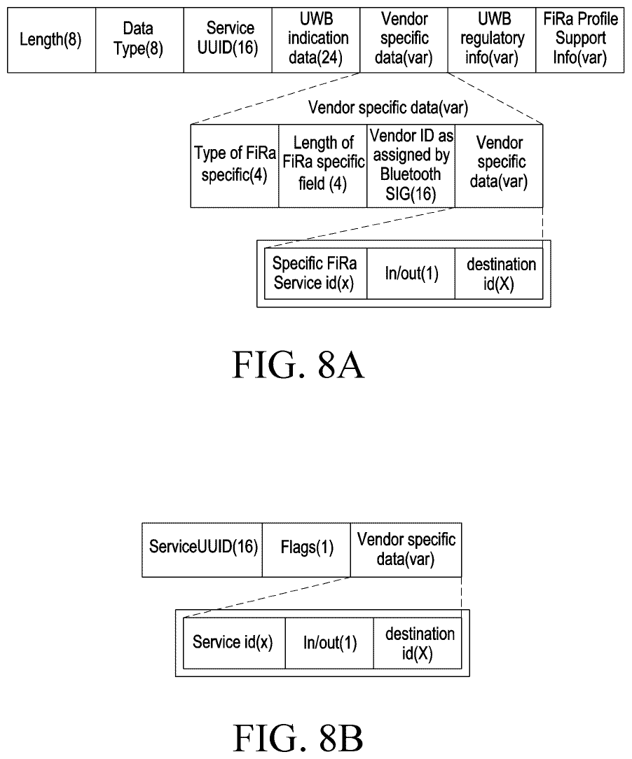

FIG. 8A illustrates an example of BLE advertisement data according to an embodiment of the disclosure.

The BLE advertisement data shown in FIG. 8A may be defined in the FiRa standard. The BLE advertisement data may include at least one of a Length field (configured as 8 bits), a Data Type field (configured as 8 bits), a Service Universally Unique Identifiers (UUID) field (configured as 16 bits), a UWB indication data field (configured as 24 bits), a Vendor specific data field (configured as variable bits), a UWB regulatory info field (configured as variable bits), and a FiRa Profile Support Info field (configured as variable bits).

The Vendor specific data field may include at least one of a Type of FiRa specific field (configured as 4 bits), a Length of FiRa specific field (configured as 4 bits), a Vendor ID as assigned by Bluetooth Special Interest Group (SIG) field (configured as 16 bits), and a Vendor specific data field (configured as variable bits).

The Vendor specific data field may include at least one of a Specific FiRa Service id field (configured as x bits (in here, x is a variable value)), an In/out field (configured as 1 bit), and a destination id field (configured as x bits (in here, x is a variable value)).

The Specific FiRa Service id field may specify an ID configured to distinguish a specific service among FiRa services. According to an embodiment, in case of “parking barrier connection” suggested in the disclosure, a new ID may be allocated and used.

The In/out field may configure a state of the electronic apparatus (or the vehicle) required to enter (or required to move into a configured place) as “in (e.g., a value of 0)” and a state of the electronic apparatus (e.g., the vehicle) required to exit (or required to move out of a configured place) as “out (e.g., a value of 1)”.

The destination id field may indicate an ID of another parking barrier with which the UWB connection is performed other than the parking barrier to which the electronic apparatus has been connected. For example, in case of a single parking barrier, the destination id field may be configured as a value of “0”.

FIG. 8B illustrates another example of BLE advertisement data according to an embodiment of the disclosure.

Referring to FIG. 8B, the BLE advertisement data may be realized as AdvData within a payload of ADV_IND. The BLE advertisement data may include at least one of a ServiceUUID field (configured as 16 bits), a Flags field (configured as 1 bit), and a Vendor specific field (configures as variable bits).

The Vendor specific data field may include at least one of a Service id field (configured as x bits (in here, x is a variable value)), an In/out field (configured as 1 bit), and a destination id field (configured as x bits (in here, x is a variable value)).

The Service id field, like the Specific FiRa Service id field, may correspond to an ID configured to distinguish a corresponding service as a specific service. For example, in the case of “parking barrier connection” exemplified in the disclosure, a predetermined ID may be allocated and used.

The In/out field may configure a vehicle in a state in which the vehicle needs to enter as “in (e.g., a value of 0)” and a vehicle in a state in which the vehicle needs to exit as “out (e.g., a value of 1)”.

The destination id field may indicate an ID of another parking barrier with which the UWB connection is performed other than the parking barrier to which the electronic apparatus has been connected. For example, in case of a single parking barrier, the destination id field may be configured as a value of “0”.

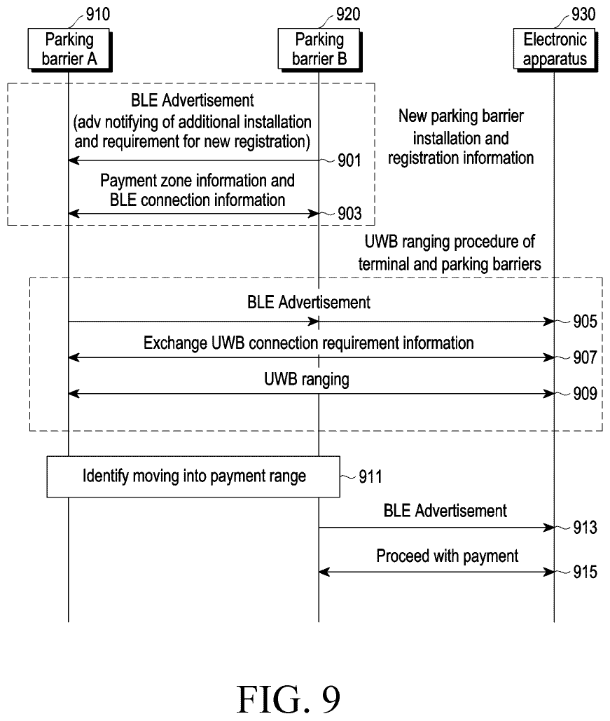

FIG. 9 illustrates a process in which BLE advertisement data is transmitted or received according to an embodiment of the disclosure.

In case that there are multiple parking barriers, one parking barrier (e.g., parking barrier A 910) may be configured to transmit BLE advertisement data. According to an embodiment, since BLE advertisement data is transmitted through only one parking barrier (e.g., parking barrier A 910), in case that a parking lot UWB payment is necessary, the electronic apparatus may scan the BLE advertisement data to directly perform BLE connection. According to an embodiment, the BLE advertisement data may include a parking barrier id and may designate a parking barrier to perform UWB connection with the electronic apparatus.

Referring to FIG. 9, in operations 901 to 903, a new parking barrier installation and information registration procedure may be performed. In operation 901, parking barrier B 920 may transmit, to parking barrier A 910, a BLE Advertisement message notifying that parking barrier B 920 is newly installed in the parking lot and requires new registration. In operation 903, parking barrier A 910 may transmit payment zone information and BLE connection information to parking barrier B 920. In operation 903, parking barrier B 920 may also transmit payment zone information and BLE connection information to parking barrier A 910.

In operations 905 to 909, a UWB ranging procedure of the electronic apparatus 930 and parking barriers 910 and 920 is described. In operation 905, parking barrier A 910 may transmit a BLE Advertisement message to parking barrier B 920 and the electronic apparatus 930. In operation 907, parking barrier A 910 may exchange information required for UWB connection with the electronic apparatus 930. In operation 909, parking barrier A 910 may perform UWB ranging with the electronic apparatus 930. According to an embodiment, parking barrier B 920 may perform UWB ranging with the electronic apparatus 930.

In operation 911, at least one of parking barrier A 910 and parking barrier B 920 may identify whether the electronic apparatus 930 has moved into a payment range (or payment zone). In operation 913, parking barrier B 920 may transmit a BLE Advertisement message to the electronic apparatus 930. In operation 915, the electronic apparatus 930 may proceed with payment based on the BLE communication and/or UWB communication with parking barrier B 920.

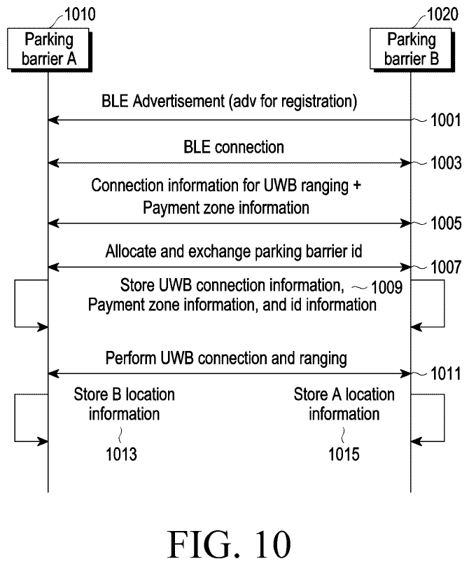

FIG. 10 illustrates a registration process between parking barriers according to an embodiment of the disclosure.

Referring to FIG. 10, in operation 1001, parking barrier B 1020 may transmit, to parking barrier A 1010, a BLE Advertisement message for registration. In operation 1003, parking barrier A 1010 and parking barrier B 1020 may establish BLE connection. In operation 1005, parking barrier A 1010 and parking barrier B 1020 may exchange at least one of connection information for UWB ranging and payment zone information. In operation 1007, parking barrier A 1010 and parking barrier B 1020 may allocate a parking barrier id and exchange the allocated id.

In operation 1009, each of parking barrier A 1010 and parking barrier B 1020 may store the UWB connection information, the payment zone information, and the allocated parking barrier id information. In operation 1011, parking barrier A 1010 and parking barrier B 1020 may perform UWB connection and ranging. In operation 1013, parking barrier A 1010 may store location information of parking barrier B 1020, based on a UWB ranging result. In operation 1015, parking barrier B 1020 may store location information of parking barrier A 1010, based on a UWB ranging result.

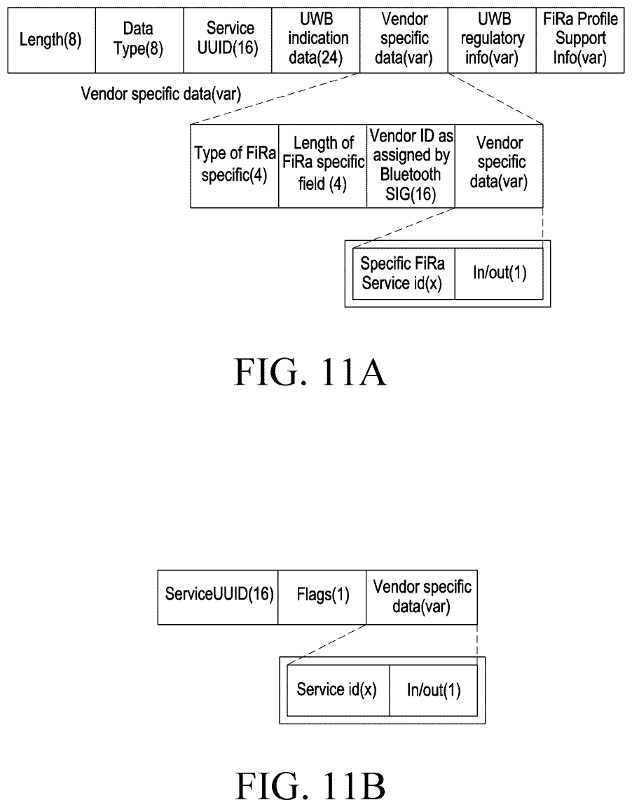

FIG. 11A illustrates an example of BLE advertisement data according to an embodiment of the disclosure.

The BLE Advertisement message for registration shown in operation 1001 of FIG. 10 is defined in the FiRa standard and may be configured as the entirety or at least a portion of the BLE advertisement data shown in FIG. 8A.

Referring to FIG. 11A, the Vendor specific data field within the BLE Advertisement message may include at least one of a Specific FiRa Service id field (configured as x bits) and an In/out field (configured as 1 bit).

The specific FiRa service id field may specify an ID configured to distinguish a service among FiRa services. According to an embodiment, in case of “parking barrier connection” suggested in the disclosure, a new ID may be allocated and used.

The In/out field may configure a state of the electronic apparatus (or the vehicle) required to enter (or required to move into a configured place) as “in (e.g., a value of 0)” and a state of the electronic apparatus (e.g., the vehicle) required to exit (or required to move out of a configured place) as “out (e.g., a value of 1)”.

FIG. 11B illustrates another example of BLE advertisement data according to an embodiment of the disclosure.

The BLE Advertisement message for registration shown in operation 1001 of FIG. 10 may be configured as the entirety or at least a portion of the BLE advertisement data shown in FIG. 8B.

Referring to FIG. 11B, the Vendor specific data field within the BLE Advertisement message may include at least one of a Service id field (configured as x bits) and an In/out field (configured as 1 bit).

The Service id field, like the Specific FiRa Service id field, may correspond to an ID configured to distinguish a corresponding service as a specific service. For example, in the case of “parking barrier connection” exemplified in the disclosure, a predetermined ID may be allocated and used.

The In/out field may configure a vehicle in a state in which the vehicle is required to enter as “in (e.g., a value of 0)” and a vehicle in a state in which the vehicle is required to exit as “out (e.g., a value of 1)”.

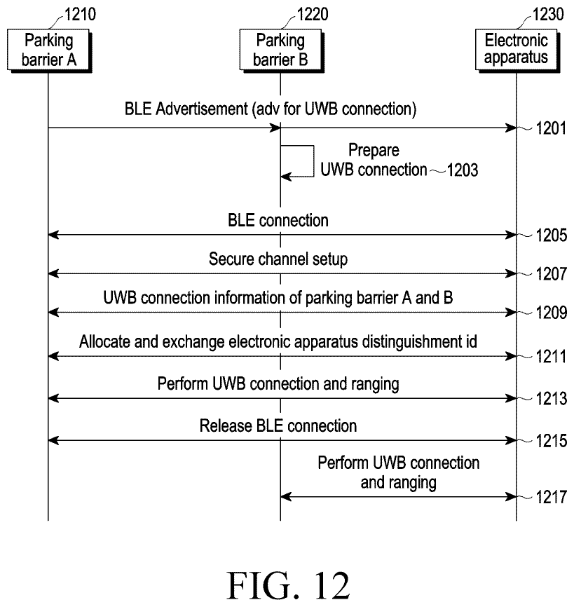

FIG. 12 illustrates a UWB connection and ranging process between a terminal and a parking barrier according to an embodiment of the disclosure.

Referring to FIG. 12, in operation 1201, parking barrier A 1210 may transmit the BLE Advertisement message for UWB connection to each of parking barrier B 1220 and the electronic apparatus 1230. In operation 1203, parking barrier B 1220 may prepare UWB connection based on the BLE Advertisement message.

In operation 1205, parking barrier A 1210 may establish UWB connection with the electronic apparatus 1230. In operation 1207, parking barrier A 1210 and the electronic apparatus 1230 may generate a Secure channel and prepare data exchange. In operation 1209, the electronic apparatus 1230 may receive information on parking barrier A 1210, information on parking barrier B 1220, and UWB connection information.

In operation 1211, at least one of parking barrier A 1210 and parking barrier B 1220 may allocate an ID configured to distinguish the electronic apparatus 1230 and exchange the ID allocated to the electronic apparatus 1230 with the electronic apparatus 1230. In operation 1213, parking barrier A 1210 and the electronic apparatus 1230 may perform UWB connection and ranging. In operation 1215, the BLE connection between parking barrier A 1210 and the electronic apparatus 1230 may be released. In operation 1217, parking barrier B 1220 and the electronic apparatus 1230 may perform UWB connection and ranging.

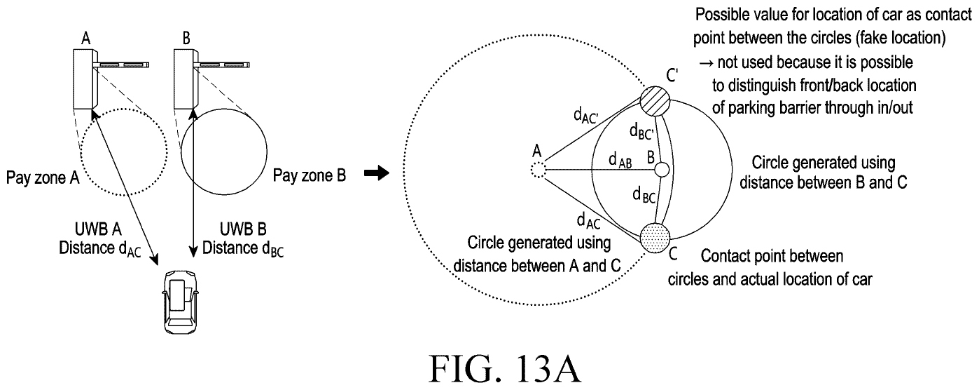

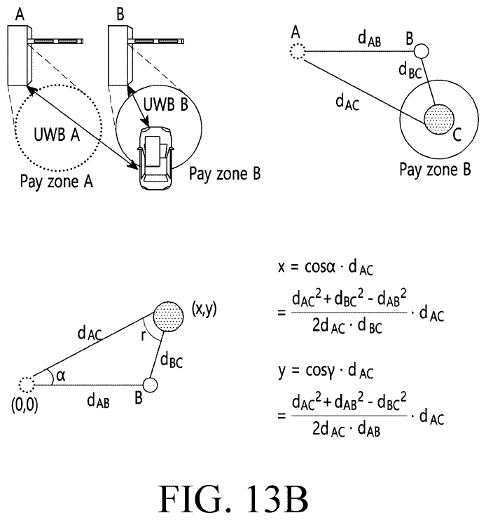

FIG. 13A illustrates an example of a process for acquiring location information of an electronic apparatus through UWB communication between two parking barriers and the electronic apparatus according to an embodiment of the disclosure.

In case that the electronic apparatus (the vehicle or the electronic apparatus in the vehicle) is connected to two parking barriers rather than to a single parking barrier, an accurate location value with respect to the electronic apparatus (the vehicle or the electronic apparatus in the vehicle) may be acquired, and whether the electronic apparatus (the vehicle or the electronic apparatus in the vehicle) has moved into the payment zone (Pay zone) may be identified.

According to an embodiment, the two parking barriers and the electronic apparatus may configure the payment zone (Pay zone) configured on each of the two parking barriers as a surface to recognize at which time point the electronic apparatus is connected to which parking barrier to proceed with the payment. According to an embodiment, the electronic apparatus may recognize a parking barrier establishing UWB connection with the electronic apparatus through the allocated id field and may receive an advertisement message from unconnected parking barrier and enable additional connection.

Referring to FIG. 13A, a first parking barrier (parking barrier A) and a second parking barrier (parking barrier B) may be installed in a parking lot, a first payment zone (pay zone A) for the first parking barrier (parking barrier A) may be configured, and a second payment zone (pay zone B) for the second parking barrier (parking barrier B) may be configured.

In case that the first parking barrier (parking barrier A) is located at “A” and the second parking barrier (parking barrier B) is located at “B”, based on a UWB ranging result (a value of d_{AC} is acquired) between the first parking barrier (parking barrier A) and the electronic apparatus (the vehicle or the electronic apparatus in the vehicle) and a UWB ranging result (a value of d_{BC} is acquired) between the second parking barrier (parking barrier B) and the electronic apparatus, it may be identified that the electronic apparatus (the vehicle or the electronic apparatus in the vehicle) is located at “C” or “C”. Depending on a state of the electronic apparatus in which the electronic apparatus (the vehicle or the electronic apparatus in the vehicle) is required to move in (entry) or move out (exit), the electronic apparatus may receive an In field or Out field included in the BLE advertisement data and then at least one of the first parking barrier (parking barrier A) and the second parking barrier (parking barrier B) may identify a position between “C” and “C”, where the electronic apparatus (the vehicle or the electronic apparatus in the vehicle) is located.

According to an embodiment, in case that the electronic apparatus (the vehicle or the electronic apparatus in the vehicle) is in the state in which the electronic apparatus is required to move in (entry), a location of the electronic apparatus may be identified as “C”.

FIG. 13B illustrates an example of a process for acquiring location information of an electronic apparatus through UWB communication between two parking barriers and the electronic apparatus according to an embodiment of the disclosure.

Referring to FIG. 13B, the first parking barrier (parking barrier A) and the second parking barrier (parking barrier B) each may identify whether the electronic apparatus has moved into a payment zone thereof through UWB ranging. Through a UWB ranging result, at least one of the first parking barrier (parking barrier A) and the second parking barrier (parking barrier B) may identify that the electronic apparatus is located within a payment zone (Pay zone B) with respect to the second parking barrier (parking barrier B).

Meanwhile, coordinates of a location of the first parking barrier (parking barrier A) may be configured as (0,0), a distance between the first parking barrier (parking barrier A) and the electronic apparatus may be configured as d_{AC}, a distance between the second parking barrier (parking barrier B) and the electronic apparatus may be configured as d_{BC}, and a distance between the first parking barrier (parking barrier A) and the second parking barrier (parking barrier B) may be configured as d_{AB}. Here, in case that coordinates of a location of the electronic apparatus is configured as (x,y), (x,y) may be calculated based on Equation 1.

$$x = cos α \cdot {d}_{A C} = \frac{{d}_{A C}^{2} + {d}_{B C}^{2} - {d}_{A B}^{2}}{2 {d}_{A C} \cdot {d}_{B C}} \cdot {d}_{A C} y = cos γ \cdot {d}_{A C} = \frac{{d}_{A C}^{2} + {d}_{A B}^{2} - {d}_{B C}^{2}}{2 {d}_{A C} \cdot {d}_{A B}} \cdot {d}_{A C} \qquad [ Equation 1 ]$$

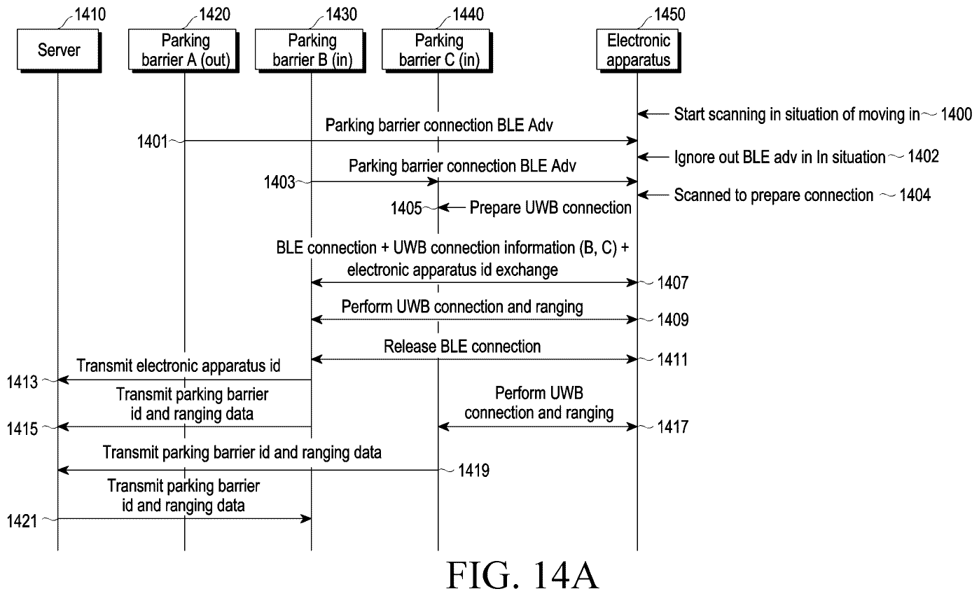

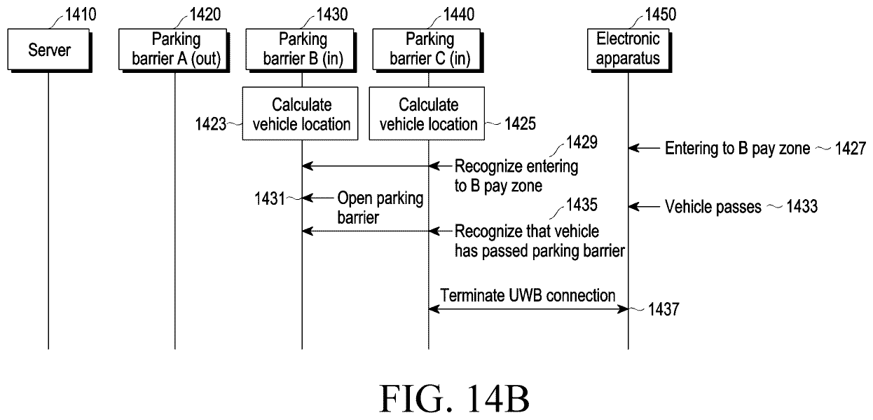

FIGS. 14A and 14B illustrate a process of an electronic apparatus moving into a parking lot in a situation in which multiple parking barriers exist according to an embodiment of the disclosure.

Referring to FIG. 14A, in operation 1400, the electronic apparatus 1450 (the vehicle or the electronic apparatus in the vehicle) may start scanning in a situation of moving into the parking lot. In operation 1401, parking barrier A (out) 1420 may transmit, to the electronic apparatus 1450, a BLE Advertisement message regarding connection with a parking barrier for moving out. In operation 1402, the electronic apparatus 1450 may ignore the BLE Advertisement message for moving out, transmitted by parking barrier A (out) 1420 in a situation of moving out of the parking lot.

In operation 1403, parking barrier B (in) 1430 may transmit, to parking barrier C (in) 1440 and the electronic apparatus 1450, a BLE Advertisement message regarding connection with a parking barrier for moving in. In operation 1404, the electronic apparatus 1450 may scan the BLE Advertisement message for moving in and prepare UWB connection. In operation 1405, parking barrier C (in) 1440 may prepare UWB connection based on the BLE Advertisement message for moving in.

In operation 1407, parking barrier B (in) 1430 and the electronic apparatus 1450 may exchange at least one of BLE connection information, UWB connection information regarding parking barrier B (in) 1430, UWB connection information regarding parking barrier C (in) 1440, and an id regarding the electronic apparatus 1450. In operation 1409, parking barrier B (in) 1430 and the electronic apparatus 1450 may perform UWB connection and ranging. In operation 1411, parking barrier B (in) 1430 and the electronic apparatus 1450 may release BLE connection.

In operation 1413, parking barrier B (in) 1430 may transmit the id regarding the electronic apparatus 1450 to a server 1410. In operation 1415, parking barrier B (in) 1430 may transmit the id and ranging data regarding the parking barrier (in) 1430 to the server 1410. In operation 1417, parking barrier C (in) 1440 may transmit the id and ranging data regarding the parking barrier C (in) 1440 to the server 1410.

In operation 1421, the server 1410 may transmit the id and ranging data regarding parking barrier C (in) 1440 to parking barrier B (in) 1430 and may transmit the id and ranging data regarding the parking barrier B (in) 1430 to parking barrier C (in) 1440.

Referring to FIG. 14B, in operation 1423, parking barrier B (in) 1430 may calculate a location of the electronic apparatus 1450 and in operation 1425, parking barrier C (in) 1440 may calculate a location of the electronic apparatus 1450.

In case that the electronic apparatus 1450 moves into the payment zone (pay zone B) for parking barrier B (in) 1430 in operation 1427, in operation 1429, at least one of parking barrier B (in) 1430 and parking barrier C (in) 1440 may recognize that the electronic apparatus 1450 has moved into the payment zone (pay zone B). Parking barrier B (in) 1430 may open a parking barrier in operation 1431, and the electronic apparatus 1450 may pass through parking barrier B (in) 1430 in operation 1433.

In operation 1435, at least one of parking barrier B (in) 1430 and parking barrier C (in) 1440 may recognize that the electronic apparatus 1450 has passed through parking barrier B (in) 1430. In operation 1437, the electronic apparatus 1450 may release UWB connection with parking barrier B (in) 1430 and parking barrier C (in) 1440.

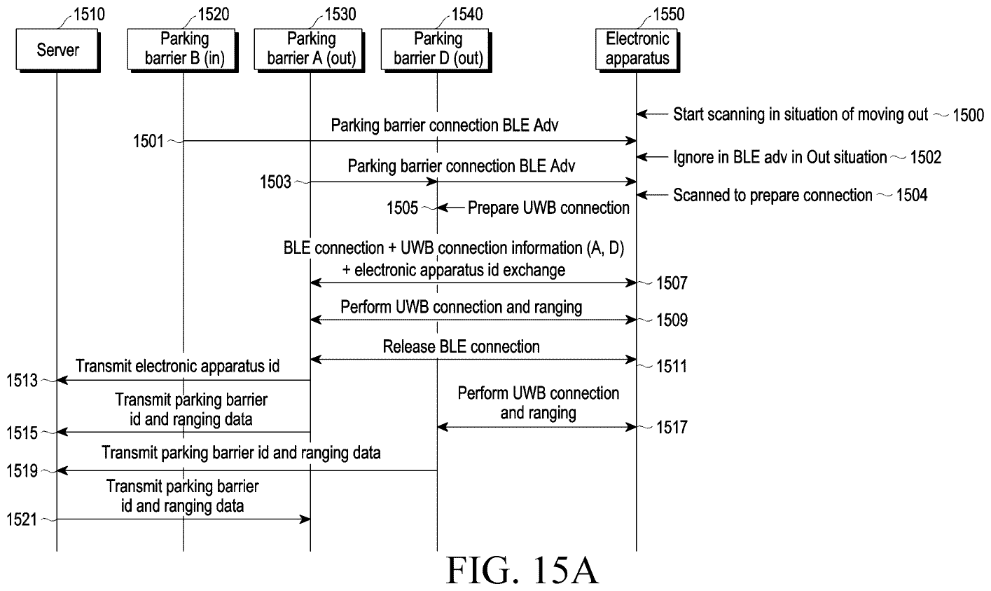

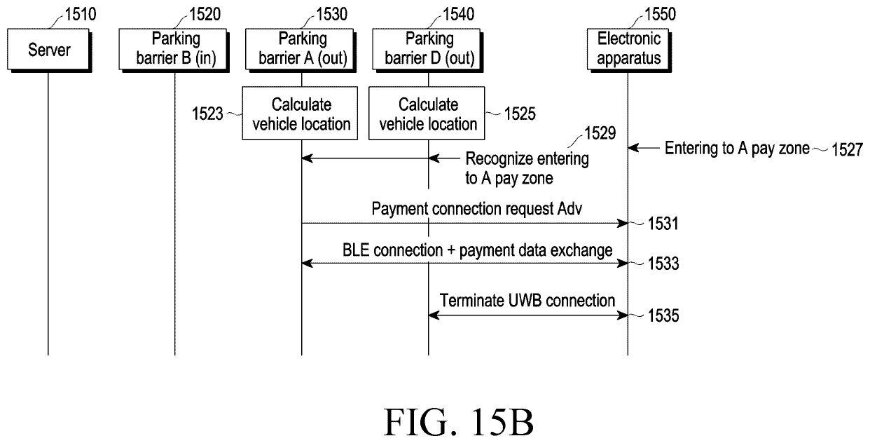

FIGS. 15A and 15B illustrate a process of an electronic apparatus moving out of a parking lot in a situation in which multiple parking barriers exist according to an embodiment of the disclosure.

Referring to FIG. 15A, in operation 1500, the electronic apparatus 1550 (the vehicle or the electronic apparatus in the vehicle) may start scanning when moving out of the parking lot. In operation 1501, parking barrier B (in) 1520 may transmit, to the electronic apparatus 1550, a BLE Advertisement message regarding connection with a parking barrier for moving in. In operation 1502, the electronic apparatus 1550 may ignore the BLE Advertisement message for moving in, transmitted by parking barrier B (in) 1520 in a situation in which the electronic apparatus is moving out of the parking lot.

In operation 1503, parking barrier A (out) 1530 may transmit, to parking barrier D (out) 1540 and the electronic apparatus 1550, a BLE Advertisement message regarding connection with a parking barrier for moving out. In operation 1504, the electronic apparatus 1550 may scan the BLE Advertisement message for “out” and prepare UWB connection. In operation 1505, parking barrier D (out) 1540 may prepare UWB connection based on the BLE Advertisement message for moving out.

In operation 1507, parking barrier A (out) 1530 and the electronic apparatus 1550 may exchange at least one of BLE connection information, UWB connection information regarding parking barrier A (out) 1530, UWB connection information regarding parking barrier D (out) 1540, and an id regarding the electronic apparatus 1550. In operation 1509, parking barrier A (out) 1530 and the electronic apparatus 1550 may perform UWB connection and ranging. In operation 1511, parking barrier A (out) 1530 and the electronic apparatus 1550 may release BLE connection.

In operation 1513, parking barrier A (out) 1530 may transmit the id regarding the electronic apparatus 1550 to a server 1510. In operation 1515, parking barrier A (out) 1530 may transmit the id and ranging data regarding the parking barrier A (out) 1530 to the server 1510. In operation 1517, parking barrier D (out) 1540 may transmit the id and ranging data regarding the parking barrier D (out) 1540 to the server 1510.

In operation 1521, the server 1510 may transmit the id and ranging data regarding parking barrier D (out) 1540 to parking barrier A (out) 1530 and may transmit the id and ranging data regarding the parking barrier A (out) 1530 to parking barrier D (out) 1540.

Referring to FIG. 15B, in operation 1523, parking barrier A (out) 1530 may calculate a location of the electronic apparatus 1550 and in operation 1525, parking barrier D (out) 1540 may calculate a location of the electronic apparatus 1550.

In case that the electronic apparatus 1550 moves into the payment zone (pay zone A) for parking barrier A (out) 1530 in operation 1527, in operation 1529, at least one of parking barrier A (out) 1530 and parking barrier D (out) 1540 may recognize that the electronic apparatus 1550 has moved into the payment zone (pay zone A).

In operation 1531, parking barrier A (out) 1530 may transmit, to the electronic apparatus 1550, a BLE Advertisement message requesting payment connection. In operation 1533, parking barrier A (out) 1530 and the electronic apparatus 1550 may establish BLE connection and exchange payment data. In operation 1535, the electronic apparatus 1550 may terminate UWB connection with parking barrier A (out) 1530 and parking barrier D (out) 1540.

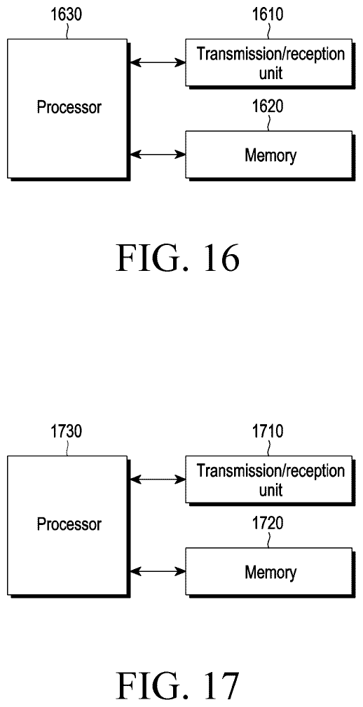

FIG. 16 illustrates a structure of a first electronic apparatus according to an embodiment of the disclosure.

The first electronic apparatus in FIG. 16 may correspond to an electronic apparatus described with reference to the electronic apparatus in FIG. 1, the first electronic apparatus or the second electronic apparatus in FIG. 2, the first electronic apparatus or the second electronic apparatus in FIG. 3, or FIGS. 4 to 15B. Referring to FIG. 16, the first electronic apparatus may include a transmission/reception unit 1610, a memory 1620, and a controller 1630.

The transmission/reception unit 1610, the controller 1630, and the memory 1620 of the first electronic apparatus may operate according to the above-described communication method of the apparatus. However, the components of the first electronic apparatus are not limited to the examples described above. For example, the first electronic apparatus may include more or fewer components than the above-described components. In addition, the transmission/reception unit 1610, the controller 1630, and the memory 1620 may be implemented in a form of a single chip. Furthermore, the controller 1630 may include one or more processors.

The transmission/reception unit 1610 may collectively refer to a receiver of the first electronic apparatus and a transmitter of the electronic apparatus and may transmit or receive a signal to or from another apparatus. To this end, the transmission/reception unit 1610 may include an RF transmitter configured to up-convert and amplify a frequency of a transmitted signal, an RF receiver configured to amplify a received signal with low noise and down-convert the frequency, and the like. This is merely an example of the transmission/reception unit 1610, and the components of the transmission/reception unit 1610 are not limited to the RF transmitter and the RF receiver.

In addition, the transmission/reception unit 1610 may receive a signal through a wireless channel, output a signal to the controller 1630, and transmit a signal output from the controller 1630 through a wireless channel.

The memory 1620 may store programs and data necessary for the operation of the first electronic apparatus. In addition, the memory 1620 may store control information or data included in a signal acquired by the first electronic apparatus. The memory 1620 may include a storage medium such as a ROM, a RAM, a hard disk, a CD-ROM, and a DVD, or a combination of storage media. In addition, the memory 1620 may not separately realized and may be included in the controller 1630.

The controller 1630 may control a series of procedures to allow the first electronic apparatus to operate according to the above-described embodiments of the disclosure.

According to an embodiment, the controller 1630 may receive, from a second electronic apparatus, a Bluetooth low energy (BLE) advertisement message including an indicator indicating a state in which the first electronic apparatus moves into a configured place or a state in which the first electronic apparatus moves out of the configured place. According to an embodiment, the BLE advertisement message may further include identifier information regarding a service provided by the second electronic apparatus and identifier information of another electronic apparatus to which the first electronic apparatus is connected.

According to an embodiment, the controller 1630 may identify whether the first electronic apparatus is to move into the configured place or move outside of the configured place. According to an embodiment, in case that a result of the identification corresponds to the indicator, the controller 1630 may establish BLE connection with the second electronic apparatus and receive ultra-wideband (UWB) connection information from the second electronic apparatus. According to an embodiment, based on the UWB connection information, the controller 1630 may establish UWB connection with the second electronic apparatus and perform UWB ranging with the second electronic apparatus.

According to an embodiment, based on the UWB connection information, the controller 1630 may establish UWB connection with a third electronic apparatus and perform UWB ranging with the third electronic apparatus. According to an embodiment, location information of the first electronic apparatus may be determined based on first information about a result of the UWB ranging between the second electronic apparatus and the first electronic apparatus and second information about a result of the UWB ranging between the third electronic apparatus and the first electronic apparatus.

According to an embodiment, the controller 1630 may receive a BLE advertisement message requesting payment connection from the second electronic apparatus. According to an embodiment, the controller 1630 may establish BLE connection and exchange payment data with the second electronic apparatus.

FIG. 17 illustrates a structure of a second electronic apparatus according to an embodiment of the disclosure.

The second electronic apparatus in FIG. 17 may correspond to a parking barrier apparatus described with reference to the electronic apparatus in FIG. 1, the first electronic apparatus or the second electronic apparatus in FIG. 2, the first electronic apparatus or the second electronic apparatus in FIG. 3, or FIGS. 4 to 15B. Referring to FIG. 17, the second electronic apparatus may include a transmission/reception unit 1710, a memory 1720, and a controller 1730.

The transmission/reception unit 1710, the controller 1730, and the memory 1720 of the second electronic apparatus may operate according to the above-described communication method of the apparatus. However, the components of the second electronic apparatus are not limited to the examples described above. For example, the second electronic apparatus may include more or fewer components than the above-described components. In addition, the transmission/reception unit 1710, the controller 1730, and the memory 1720 may be implemented in a form of a single chip. Furthermore, the controller 1730 may include one or more processors.

The transmission/reception unit 1710 may collectively refer to a receiver of the second electronic apparatus and a transmitter of the electronic apparatus and may transmit or receive a signal to or from another apparatus. To this end, the transmission/reception unit 1710 may include an RF transmitter configured to up-convert and amplify a frequency of a transmitted signal, an RF receiver configured to amplify a received signal with low noise and down-convert the frequency, and the like. This is merely an example of the transmission/reception unit 1710, and the components of the transmission/reception unit 1710 are not limited to the RF transmitter and the RF receiver.

In addition, the transmission/reception unit 1710 may receive a signal through a wireless channel, output a signal to the controller 1730, and transmit a signal output from the controller 1730 through a wireless channel.

The memory 1720 may store programs and data necessary for the operation of the second electronic apparatus. In addition, the memory 1720 may store control information or data included in a signal acquired by the second electronic apparatus. The memory 1720 may include a storage medium such as a ROM, a RAM, a hard disk, a CD-ROM, and a DVD, or a combination of storage media. In addition, the memory 1720 may not separately realized and may be included in the controller 1730.

The controller 1730 may control a series of procedures to allow the second electronic apparatus to operate according to the above-described embodiments of the disclosure.

According to an embodiment, the controller 1730 may control a Bluetooth low energy (BLE) advertisement message including an indicator indicating a state in which the first electronic apparatus moves into a configured place or a state in which the first electronic apparatus moves out of the configured place to be transmitted to the first electronic apparatus. According to an embodiment, the controller 1730 may establish BLE connection with the first electronic apparatus and control ultra-wideband (UWB) connection information to be transmitted to the first electronic apparatus. According to an embodiment, based on the UWB connection information, the controller 1730 may establish UWB connection with the first electronic apparatus and perform UWB ranging with the first electronic apparatus.

According to an embodiment, the controller 1730 may control identification information of the second electronic apparatus and first information about a result of the UWB ranging between the second electronic apparatus and the first electronic apparatus to be transmitted to a server. According to an embodiment, the controller 1730 may receive, from the server, identification information of a third electronic apparatus and second information about a result of the UWB ranging between the third electronic apparatus and the first electronic apparatus.

According to an embodiment, the controller 1730 may determine location information of the first electronic apparatus based on first information about a result of the UWB ranging between the second electronic apparatus and the first electronic apparatus and second information about a result of the UWB ranging between the third electronic apparatus and the first electronic apparatus.

According to an embodiment, the controller 1730 may control a BLE advertisement message requesting payment connection to be transmitted to the first electronic apparatus. According to an embodiment, the controller 1730 may establish BLE connection and exchange payment data with the first electronic apparatus.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

Although the present disclosure has been described with various embodiments, various changes and modifications may be suggested to one skilled in the art. It is intended that the present disclosure encompass such changes and modifications as fall within the scope of the appended claims.

What is claimed is:

1. An operation method of a first electronic apparatus in a wireless communication system, the method comprising:
receiving, from a second electronic apparatus, a Bluetooth low energy (BLE) advertisement message comprising an indicator indicating a state in which the first electronic apparatus moves into a configured place or a state in which the first electronic apparatus moves out of the configured place;
identifying whether the first electronic apparatus is to move into the configured place or move out of the configured place;
establishing, in case that a result of the identification corresponds to the indicator, a BLE connection with the second electronic apparatus and receiving ultra-wideband (UWB) connection information from the second electronic apparatus; and
establishing a UWB connection with the second electronic apparatus and performing UWB ranging with the second electronic apparatus based on the UWB connection information.

2. The method of claim 1, further comprising establishing UWB connection with a third electronic apparatus and performing UWB ranging with the third electronic apparatus, based on the UWB connection information.

3. The method of claim 2, wherein location information of the first electronic apparatus is determined based on first information about a result of the UWB ranging between the second electronic apparatus and the first electronic apparatus and second information about a result of the UWB ranging between the third electronic apparatus and the first electronic apparatus.

4. The method of claim 1, further comprising:
receiving a second BLE advertisement message requesting payment connection from the second electronic apparatus; and
establishing a BLE connection for payment and exchanging payment data with the second electronic apparatus.

5. The method of claim 1, wherein the BLE advertisement message further comprises identifier information regarding a service provided by the second electronic apparatus and identifier information of another electronic apparatus to which the first electronic apparatus is connected.

6. An operation method of a second electronic apparatus in a wireless communication system, the method comprising:
transmitting, to a first electronic apparatus, a Bluetooth low energy (BLE) advertisement message comprising an indicator indicating a state in which the first electronic apparatus moves into a configured place or a state in which the first electronic apparatus moves out of the configured place;
establishing a BLE connection with the first electronic apparatus and transmitting ultra-wideband (UWB) connection information to the first electronic apparatus; and
establishing a UWB connection with the first electronic apparatus and performing UWB ranging based on the UWB connection information.

7. The method of claim 6, further comprising:
transmitting, to a server, identification information of the second electronic apparatus and first information about a result of the UWB ranging between the second electronic apparatus and the first electronic apparatus; and
receiving, from the server, identification information of a third electronic apparatus and second information about a result of UWB ranging between the third electronic apparatus and the first electronic apparatus.

8. The method of claim 7, further comprising determining location information of the first electronic apparatus, based on the first information about the result of the UWB ranging between the second electronic apparatus and the first electronic apparatus and the second information about the result of the UWB ranging between the third electronic apparatus and the first electronic apparatus.

9. The method of claim 6, further comprising:
transmitting, to the first electronic apparatus, a second BLE advertisement message requesting payment connection; and
establishing a BLE connection for payment and exchanging payment data with the first electronic apparatus.

10. The method of claim 6, wherein the BLE advertisement message further comprises identifier information regarding a service provided by the second electronic apparatus and identifier information of another electronic apparatus to which the first electronic apparatus is connected.

11. A first electronic apparatus in a wireless communication system, the first electronic apparatus comprising:
a transmission/reception unit; and
a controller, wherein the controller is configured to:
receive, from a second electronic apparatus, a Bluetooth low energy (BLE) advertisement message comprising an indicator indicating a state in which the first electronic apparatus moves into a configured place or a state in which the first electronic apparatus moves out of the configured place;
identify whether the first electronic apparatus is to move into the configured place or move outside of the configured place;
establish, in case that a result of the identification corresponds to the indicator, a BLE connection with the second electronic apparatus and receive ultra-wideband (UWB) connection information from the second electronic apparatus; and
establish a UWB connection with the second electronic apparatus and perform UWB ranging with the second electronic apparatus based on the UWB connection information.

12. The apparatus of claim 11, wherein the controller is configured to establish UWB connection with a third electronic apparatus and perform UWB ranging with the third electronic apparatus, based on the UWB connection information.

13. The apparatus of claim 12, wherein location information of the first electronic apparatus is determined based on first information about a result of the UWB ranging between the second electronic apparatus and the first electronic apparatus and second information about a result of the UWB ranging between the third electronic apparatus and the first electronic apparatus.

14. The apparatus of claim 11, wherein the controller is configured to:
receive a second BLE advertisement message requesting payment connection from the second electronic apparatus; and
establish a BLE connection for payment and exchange payment data with the second electronic apparatus.

15. The apparatus of claim 11, wherein the BLE advertisement message further comprises identifier information regarding a service provided by the second electronic apparatus and identifier information of another electronic apparatus to which the first electronic apparatus is connected.

16. A second electronic apparatus in a wireless communication system, the second electronic apparatus comprising:
a transmission/reception unit; and
a controller, wherein the controller is configured to:
transmit, to a first electronic apparatus, a Bluetooth low energy (BLE) advertisement message comprising an indicator indicating a state in which the first electronic apparatus moves into a configured place or a state in which the first electronic apparatus moves out of the configured place;
establish a BLE connection with the first electronic apparatus and transmit ultra-wideband (UWB) connection information to the first electronic apparatus; and
establish a UWB connection with the first electronic apparatus and perform UWB ranging based on the UWB connection information.

17. The apparatus of claim 16, wherein the controller is configured to:
transmit, to a server, identification information of the second electronic apparatus and first information about a result of the UWB ranging between the second electronic apparatus and the first electronic apparatus; and
receive, from the server, identification information of a third electronic apparatus and second information about a result of UWB ranging between the third electronic apparatus and the first electronic apparatus.

18. The apparatus of claim 17, wherein the controller is configured to determine location information of the first electronic apparatus based on the first information about the result of the UWB ranging between the second electronic apparatus and the first electronic apparatus and the second information about the result of the UWB ranging between the third electronic apparatus and the first electronic apparatus.

19. The apparatus of claim 16, wherein the controller is configured to:
transmit a second BLE advertisement message requesting payment connection to be transmitted to the first electronic apparatus; and
establish a BLE connection for payment and exchange payment data with the first electronic apparatus.

20. The apparatus of claim 16, wherein the BLE advertisement message further comprises identifier information regarding a service provided by the second electronic apparatus and identifier information of another electronic apparatus to which the first electronic apparatus is connected.
